(19) United States
(12) Patent Application Publication
(10) Pub. No.: US 2012/0298884 A1
(43) Pub. Date: Nov. 29, 2012

(54) Ion Milling Device, Sample Processing Method, Processing Device, and Sample Drive Mechanism

(75) Inventors: Rie Nakajima, Hitachinaka (JP); Koichi Kurosawa, Hitachi (JP); Hisayuki Takasu, Oarai (JP)

(73) Assignee: Hitachi High-Technologies Corporation, Minato-ku, Tokyo (JP)

(21) Appl. No.: 13/575,381

(22) PCT Filed: Jan. 26, 2011
(86) PCT No.: PCT/JP2011/051451

§ 371 Date: Jul. 26, 2012

(30) Foreign Application Priority Data
Jan. 28, 2010 (JP) 2010-016156

(51) Int. Cl. G21K 5/10

(52) U.S. Cl. 250/453.11

(57) ABSTRACT

In view of the above-mentioned problems, an object of the present invention is to provide a processing method that is not dependent on the material or the ion beam irradiation angle. In order to achieve the object above, the present invention provides a processing device that processes a sample by irradiating the sample with an ion beam, the processing device comprising a sample tilting/rotating mechanism that rotates/tilts the sample relative to the ion beam, wherein the sample rotating mechanism comprises a rotating shaft that rotates the sample relative to the ion beam, and a tilting shaft that is orthogonal to the rotating shaft and that tilts the sample relative to the ion beam, the sample rotating mechanism being adapted to simultaneously perform the rotating and tilting of the sample.

### TECHNICAL FIELD

The present invention relates to an ion milling device and a scanning electron microscope sample processing method, and, more particularly, to an ion milling device and a scanning electron microscope sample processing method for preparing a sample to be observed/analyzed using a scanning electron microscope or an EBSP (Electron BackScatter diffraction Pattern) method, etc.

### BACKGROUND ART

Along with the rapid advancements in packaging technology for electronic devices in recent years, constituent components of electronic components have also become smaller and denser, and SEM observation/analysis needs for the internal structures thereof are growing rapidly.

With sample surfaces prepared by a mechanical polishing method for the purpose of sample internal structure observation, sometimes fine structures are unobservable/unanalyzable due to deformation, polishing damage, or drooping caused by the stress exerted during polishing. To address this, ion milling is applied as a finishing to mechanical polishing.

Ion milling is a method of processing a sample with no stress through sputtering, where accelerated ions are fired at a sample, and the fired ions eject atoms and molecules at the sample surface. It is used as a sample pre-treatment method for analyzing, using an SEM, laminar shape, film thickness evaluation, crystal state, defects, or foreign matter cross-sections with respect to sample surfaces and internal structures.

As conventional examples of ion milling devices, there are the techniques of Patent Documents 1 to 3.

It is stated in Patent Document 1 that a processed surface of approximately 5 mm in diameter is obtained by placing a sample on a rotating body, and performing ion milling with the axis of rotation and the sample surface irradiation position of the ion beam center offset by a predetermined distance.

It is stated in Patent Document 2 that the processing state is checked by disposing inside an ion milling device a probe with a built-in video camera.

Patent Document 3 describes an ion milling method and ion milling device that are suitable for aligning the site that is irradiated with an ion beam with the processing target position.

### PRIOR ART DOCUMENTS

### Patent Documents

Patent Document 1: JP Patent Application Publication (Kokai) No. 3-36285 A (1991)
Patent Document 2: JP Patent Application Publication (Kokai) No. 10-140348 A (1998)
Patent Document 3: JP Patent Application Publication (Kokai) No. 2007-83262 A

### SUMMARY OF THE INVENTION

### Problem to be Solved by the Invention

Deformation, polishing damage, and drooping caused by the stress exerted during polishing are formed on a sample surface prepared through a mechanical polishing method, and ion milling is applied to remove them.

However, the milling rate is dependent on the material and the ion beam irradiation angle. Accordingly, there was a problem in that, in the case of composite materials comprising materials with varying milling rates, a smooth processed surface for fine structure analysis could not be obtained with conventional ion milling in which the ion beam irradiation angle with respect to the sample is fixed.

In addition, in order to check whether the processing required for observation/analysis is being carried out successfully, it is necessary that the sample be removed from the ion milling device and observed and checked with an optical microscope or SEM, thus requiring effort and time.

In view of the problems above, it is an object of the present invention to provide a processing method that is not dependent on the material or the ion beam irradiation angle, and, further, to provide a means with which end point detection by ion milling may be performed with ease.

### Solution to the Problem

With a view to achieving the object above, the present invention provides a processing device that processes a sample by irradiating the sample with an ion beam, the processing device comprising a sample tilting/rotating mechanism that rotates/tilts the sample relative to the ion beam, wherein the sample rotating mechanism comprises a rotating shaft that rotates the sample relative to the ion beam, and a tilting shaft that is orthogonal to the rotating shaft and that tilts the sample relative to the ion beam, the sample tilting/rotating mechanism being adapted to simultaneously perform the rotating and tilting of the sample.

In addition, end point detection is achieved by a processing device comprising an electron irradiation system that irradiates a sample with an electron beam, a detector that detects electrons generated from the sample, and a control device that terminates the irradiating of the sample with the ion beam based on a signal detected by the detector, or by a processing device comprising a laser irradiation system for irradiating a sample with laser light, a detector that detects laser light reflected or scattered by the sample, and a control device that terminates the irradiating of the sample with the ion beam based on a signal detected by the detector.

### Advantageous Effects of the Invention

With the present invention, by continuously varying the ion beam irradiation angle, a smooth processed surface that is not dependent on the material or the ion beam irradiation angle even for composite materials may be obtained. In addition, by providing an ion milling device with an electron irradiation system capable of irradiating a sample with an electron beam and a function for detecting and displaying electrons generated from the sample, and processing the obtained signal, or by providing an ion milling device with an optical system for irradiating a sample with laser light and a function for detecting laser light reflected or scattered from the sample, and processing the detected laser light, end point detection is carried out, and end point detection of processing without removing the sample becomes possible.

### BRIEF DESCRIPTION OF THE DRAWINGS

FIG. 1 is a diagram illustrating an ion milling device comprising a sample rotating/tilting mechanism, which represents claims 1 and 2, as well as Embodiment 1.

FIG. 2 is a detailed illustrative diagram of a sample tilting/rotating mechanism.

FIG. 3 is a detailed illustrative diagram of a sample tilting/rotating mechanism.

FIG. 4 is an illustrative diagram showing a comparison between processed surfaces by a conventional ion milling method and an ion milling method according to the present invention.

FIG. 5 is a detailed illustrative diagram regarding irradiation angle, which is varied continuously by a sample tilting/rotating mechanism.

FIG. 6 is a detailed illustrative diagram regarding processing ranges that may be varied by way of the stage tilt angle.

FIG. 7 is an illustrative diagram of an ion milling device comprising a sample tilting/rotating mechanism and SEM functionality.

FIG. 8 is a detailed illustrative diagram of an ion milling device comprising a sample tilting/rotating mechanism and SEM functionality.

FIG. 9 is an illustrative diagram of ion milling end point detection.

FIG. 10 is an illustrative diagram of an ion milling device comprising a sample tilting/rotating mechanism and a laser light irradiation function.

FIG. 11 is an illustrative diagram of ion milling end point detection.

### MODES FOR CARRYING OUT THE INVENTION

Embodiments of the present invention are described below based on the drawings.

### Embodiment 1

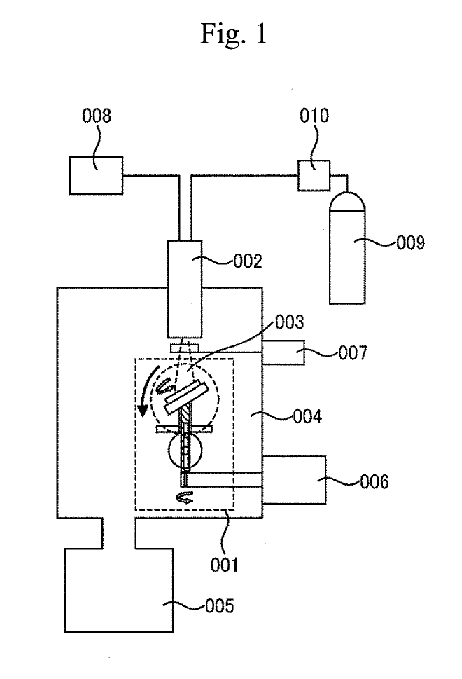

FIG. 1 is a diagram showing one embodiment of an ion milling device to which the present invention is applied. It comprises: a sample stage 006 equipped with a sample tilting/rotating mechanism 001 according to the present invention that is capable of continuously varying the irradiation angle of an ion beam with which a sample is irradiated, and which is shown enclosed by broken lines in FIG. 1; an ion source 002; a sample chamber 004; an evacuating system 005; an ion current measurement device 007; a high-voltage unit 008; and a gas supply source 009.

The sample tilting/rotating mechanism 001 of the present embodiment is disposed within the sample chamber 004 via the sample stage 006. The sample chamber 004 has the interior of the sample chamber controlled to atmospheric pressure or a vacuum by the evacuating system 005, and is capable of holding that state.

The ion source 002 refers to an irradiation system comprising all the elements for emitting an ion beam 003.

In addition, the sample stage 006 refers to a mechanism/system comprising all the elements for rotating and tilting forward/backward/left/right/up/down to irradiate a sample 101 with the ion beam 003 at any given spot.

Next, continuous tilting/rotating of a sample is described taking the sample tilting/rotating mechanism 001 according to the present invention as an example.

The sample tilting/rotating mechanism 001 of the present embodiment is a mechanism for continuously varying the irradiation angle in emitting the ion beam 003 from the ion source 002, instead of using a fixed irradiation angle that is dependent on the tilt angle of the sample stage 006. It has a sample rotating function and tilting function.

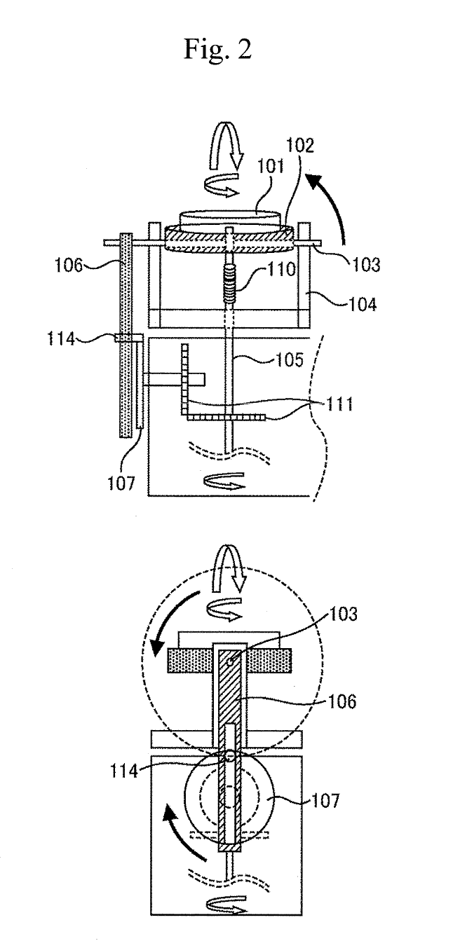

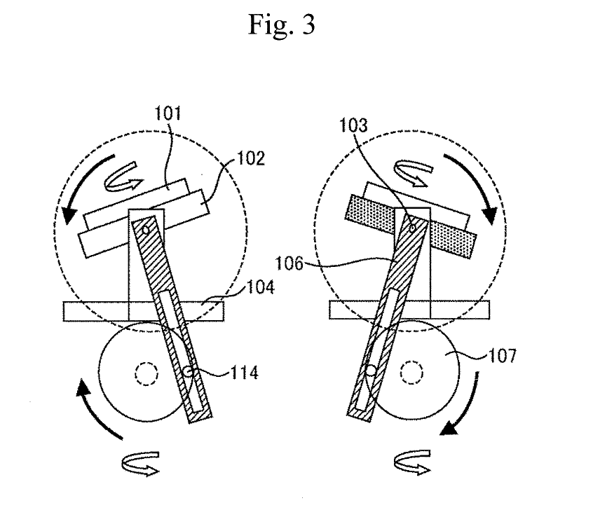

The sample rotating function and tilting function are described below in detail using FIG. 2 and FIG. 3.

FIG. 2 is an example where a rotating shaft 105 in FIG. 2 is rotated with the rotating mechanism of the sample stage 006 as a drive source. As the rotating shaft 105 rotates, a rotating plate 107 rotates via an inside gear 111 attached to the rotating shaft 105. As the rotating plate 107 rotates, a drive arm 106 is also driven by a pin 114 attached to the rotating plate 107, and a sample table 102 attached to a tilting shaft 103 moves up/down about the tilting shaft 103. Further, the sample 101 mounted on the sample table 102 rotates due to the rotating shaft 105. The rotation of the rotating shaft 105 rotates the sample 101 by being transmitted by a spring 110. The spring 110 transmits the rotary drive to the sample 101 even when the sample table is tilted. The sample table 102 does not rotate and is provided with an opening through which the upper portion of the rotating shaft 105 passes. Alternatively, the sample table 102 may be of a dual structure, where the inner part on which the sample 101 is mounted is connected to the upper portion of the rotating shaft 105 and rotates, and where the outer part connected to the tilting shaft 103 does not rotate.

These upward/downward and rotary motions are enabled by the spring 110 attached to the rotating shaft 105 without restricting each motion.

By virtue of the sample tilting/rotating mechanism 001 and the sample stage 006, as shown in FIG. 3, the sample 101 is irradiated with the ion beam 003 in a continuously varied manner by means of; in addition to the sample tilt by the sample stage 006, the continuous tilt by the tilting shaft 103 and the rotation by the rotating shaft 105. Accordingly, a smooth processed surface, which is necessary for fine structure analysis, that is not dependent on differences in milling rate caused by the material or ion beam irradiation angle, which was difficult with conventional methods, may be obtained.

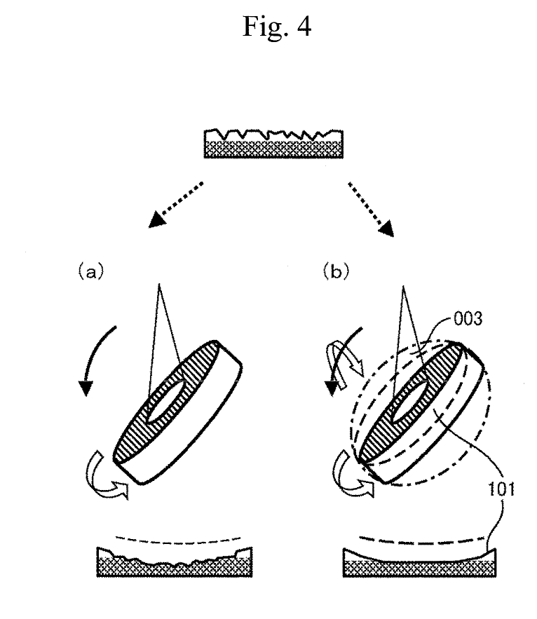

FIG. 4 is an illustrative diagram showing a comparison of processed surfaces by a conventional ion milling method and an ion milling method according to the present invention.

FIG. 4(a) shows a processed surface by a conventional ion milling method in which an ion beam is emitted at a fixed irradiation angle. With the conventional method, because the milling rate for the sample is dependent on the material and the ion beam irradiation angle, dents and bumps reflecting the material and crystal orientation are formed in/on the processed surface. On the other hand, with processing based on an ion milling method of the present invention as shown in FIG. 4(b), because the sample is irradiated with an ion beam continuously and from various directions, problems are solved, and it becomes possible to form a smooth processed surface.

### Embodiment 2

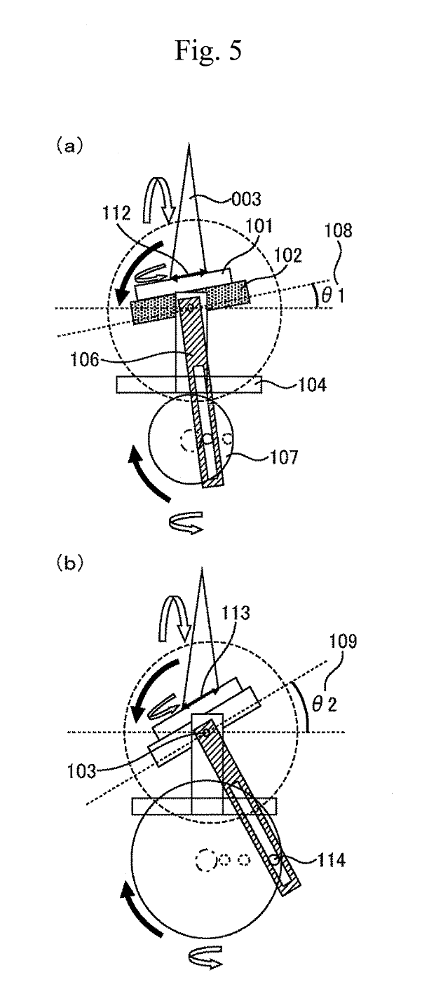

FIG. 5 is a diagram showing another embodiment of the present invention. It is an illustrative diagram regarding the angle at which the sample is irradiated with the ion beam 003, which is varied continuously by means of the sample rotating/tilting mechanism 001, in other words, sample tilt angle (θ) in the context of the present invention. The range for sample tilt angle (θ) may be altered by having the range of motion of the drive arm 106 be variable.

Specifically, by disposing the pin 114 attached to the rotating plate 107 that drives the drive arm 106 towards the inner side of the rotating plate 107, or by making the rotating plate 107 smaller, sample tilt angle (θ1) 108 may be decreased as shown in FIG. 5(a). In addition, by disposing the pin 114 attached to the rotating plate 107 that drives the drive arm 106 towards the outer side of the rotating plate 107, or by making the rotating plate 107 bigger, sample tilt angle (θ2) 109 may be increased as shown in FIG. 5(b).

Thus, the range for the continuously variable sample tilt angle (as in tilt angle (θ1) 108 and tilt angle 109 (θ2)) may be altered by way of the position of the pin 114 attached to the rotating plate 107.

By way of example, in the case of sample tilt angle (θ1) 108, an irradiation range 112 of the ion beam 003 becomes narrower. In the case of sample tile angle (θ2) 109, an irradiation range 113 of the ion beam 003 becomes wider. In other words, the ion beam 003 is emitted over a wide range, and the processing range becomes wider. Accordingly, through tilt angle (θ), which is determined by the drive arm 106 and the rotating plate 107, it becomes possible to alter the processing range with ease. In addition, by altering the sample tilt angle, it is possible to obtain a smooth flat surface with various samples.

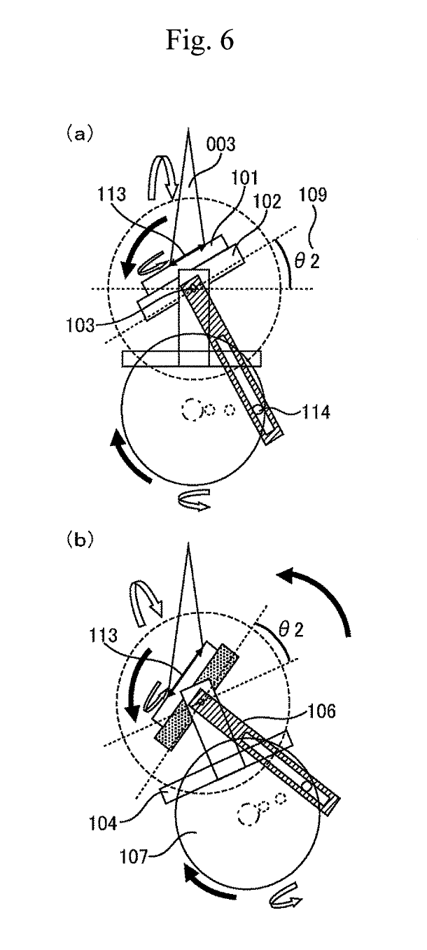

In addition, with respect to FIG. 6, by using the range for sample tilt angle (θ2) 109 by the sample tilting/rotating mechanism 001 shown in FIG. 5 in combination with the tilt angle of the sample stage 006 shown in FIG. 6, the processing range may be further reduced or enlarged.

Since, by employing the present invention, it becomes possible to vary the irradiation density of the ion beam 003 with which the sample 101 is irradiated, it is also possible to realize the controlling of processing speed in accordance with the sample being processed.

### Embodiment 3

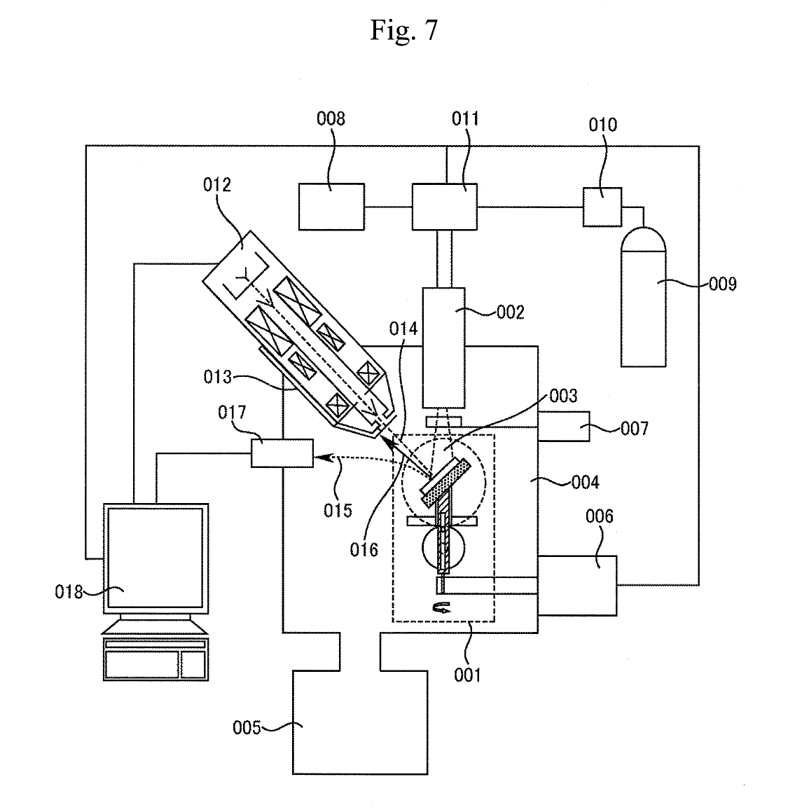

FIG. 7 is a diagram showing an embodiment of end point detection of processing of an ion milling device of the present invention.

For the present embodiment, a description is provided with respect to a case where an ion milling device according to the present invention is provided with SEM functionality.

SEM functionality comprises basic functions of a common SEM comprising a secondary electron detector 017 and a backscattered electron detector 013 for detecting signals of secondary electrons 015 and backscattered electrons 016, etc., emitted from the sample 101 when the sample 101 is irradiated with an electron beam 014 by an electron gun 012, wherein the signals are displayed as a two-dimensional image, and so forth.

An ion milling/SEM control system unit 018 comprises a function of controlling the above-mentioned basic functions of a common SEM as well as displaying the image brightness of a two-dimensional image as a line profile, and a function of controlling an ion milling device.

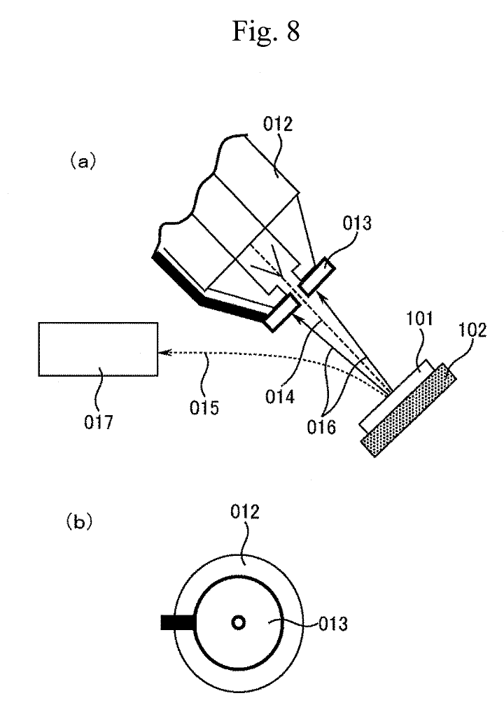

FIG. 8 is a diagram showing the positions of the electron gun 012, the secondary electron detector 017, and the backscattered electron detector 013. As shown in FIG. 8(a), the backscattered electron detector 013 comprises an opening through which the electron beam emitted from the electron gun 012 passes. In addition, FIG. 8(b) shows the backscattered electron detector 013 as viewed from the sample 101 side.

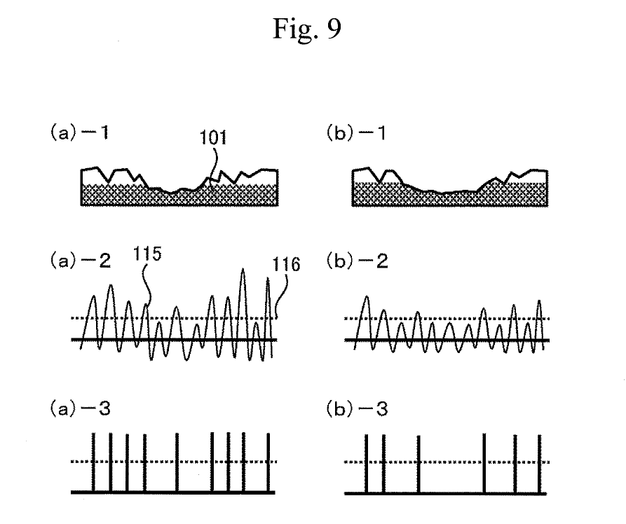

FIG. 9 is an illustrative diagram regarding end point detection using SEM functionality.

When performing end point detection using the SEM functionality with which the ion milling device is provided, the unprocessed sample 101 is scanned with the electron beam 014 from the electron gun 012, the secondary electrons 015 and backscattered electrons 016 generated from the sample 101 are detected with the secondary electron detector 017 and the backscattered electron detector 013, and an image reflecting the dents/bumps in/on the sample surface and its composition is acquired. It is noted that, when acquiring an image, in order to facilitate SEM observation by the ion milling/SEM control system unit 018 before, after or during processing, the sample 101 is always turned towards the electron gun 012 and held stationary.

Next, the acquired image is processed at the ion milling/SEM control system unit 018, and a line profile 115 reflecting the dents and bumps in/on the sample is displayed. In so doing, for the unprocessed sample 101, due to the dents and bumps in/on the sample 101 such as those shown in FIG. 9(a)-1, a line profile 115 such as that shown in FIG. 9(a)-2 is displayed.

A thresholding process such as that shown in FIG. 9(a)-3 is performed on this line profile 115 with a threshold 116 that has been set, and the number of peaks that are at or above the threshold 116 is counted and stored.

Ion milling processing according to the present invention is then performed, and, in a manner similar to that discussed above, the number of peaks that are at or above the threshold 116 is counted and stored. By automatically repeating the above, as the duration of ion milling processing becomes longer, the dents and bumps in/on the sample 101 decrease as shown in FIG. 9(b)-1, the line profile 115 reflecting the dents and bumps in/on the sample 101 also changes as shown in FIG. 9(b)-2, and the results of thresholding the line profile also change as in FIG. 9(b)-3.

By determining it to be the end at the point at which the number of peaks becomes equal to or less than a pre-defined number and suspending ion milling processing, end point detection becomes possible. Further, by altering the processing condition settings or the processing duration per session, as well as providing a plurality of thresholds 116, it also becomes possible to perform mid-processing control.

Further, with respect to image acquisition, too, since both the secondary electron detector 017 and the backscattered electron detector 013 are provided, it is possible to acquire an optimal image suited for the sample 101. By way of example, for a sample 101 that is not electrically conductive, since low-vacuum observation using the backscattered electrons 016, which are high-energy electrons, is possible by means of the gas supplied from the gas supply source 009, end point detection becomes possible while also avoiding charging caused by the electron beam 014.

In addition, when the backscattered electrons 016 are used, since they may be detected separately from the secondary electrons 015, which are low-energy electrons emitted from the sample 101 due to irradiation by the electron beam 014, end point detection becomes possible without having to suspend the ion beam 003 at the time of image acquisition.

As mentioned above, with an ion milling device comprising SEM functionality according to the present invention, by processing electron information, etc., obtained by irradiating the sample 101 with the electron beam 014, it is possible to determine the completion of ion milling processing.

### Embodiment 4

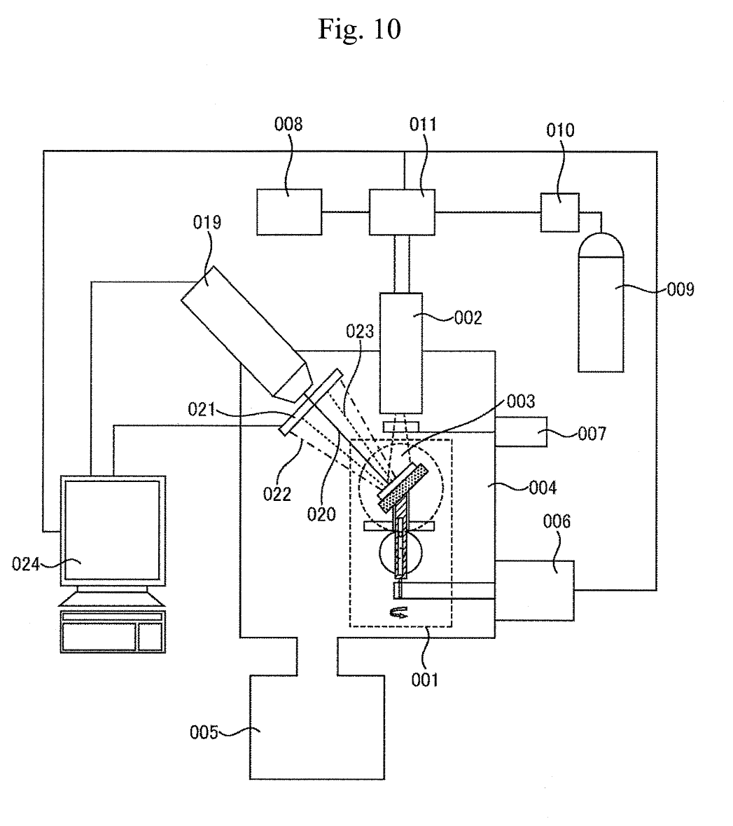

FIG. 10 is a diagram showing another embodiment of end point detection.

For the present embodiment, a description is provided with respect to a case where an ion milling device according to the present invention is provided with a laser irradiation function.

The laser irradiation function comprises all the functions of emitting laser light 020 from a laser light source 019, comprising, directly below the laser light source 019, a ring-shaped detector 021 that detects light reflected or scattered by the sample 101, and processing and displaying those signals.

An ion milling/laser irradiation control system 024 controls the ion milling device and laser irradiation function according to the present invention. When performing laser emission before, after, or during processing, the sample 101 is always turned towards the laser light source 019 and held stationary.

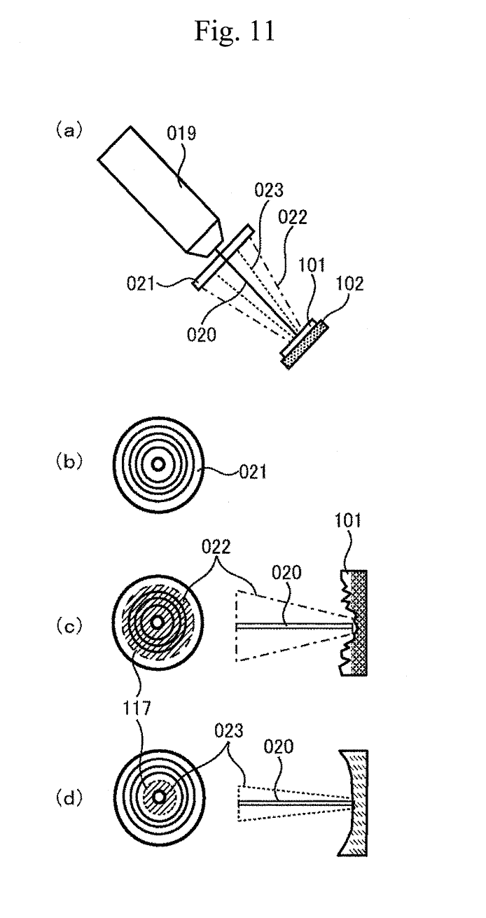

FIG. 11 is a diagram showing the present embodiment in detail. In FIG. 11(a), the laser light 020 is emitted from the laser light source 019. The ring-shaped detector 021 that detects the light reflected or scattered by the sample 101 comprises an opening through which the laser light 020 emitted from the laser light source 019 passes. FIG. 11(b) shows the ring-shaped detector 021 as viewed from the sample side.

When performing end point detection using the laser irradiation function with which the ion milling device is provided, the unprocessed sample 101 is irradiated with the laser light 020 from the laser light source 019. Since the laser light 020 is diffusely reflected or significantly scattered due to the dents and bumps in/on the sample 101, the number of rings 117 at which reflected/scattered light 022 is detected at the ring-shaped detector 021 increases as shown in FIG. 11(c). This number of detected rings prior to processing is counted and stored by the ion milling/laser irradiation control system 024.

Ion milling processing according to the present invention is then performed, and, in a manner similar to that discussed above, the number of rings 117 at which scattered light 023 after processing is detected is counted and stored. By automatically repeating the above, as the duration of ion milling processing becomes longer, the dents and bumps in/on the sample 101 decrease, and the number of rings 117 at which the scattered light 023 after processing is detected also decreases as shown in FIG. 11(d).

By determining it to be the end at the point at which the number of rings 117 at which the scattered light 023 after processing is detected becomes equal to or less than a pre-defined number and suspending ion milling processing, end point detection becomes possible. In addition, by altering the processing condition settings or the processing duration per session, as well as increasing/decreasing, or providing a plurality of, the rings 117 of the ring shaped detector 021, it also becomes possible to perform mid-processing control.

Thus, with an ion milling device comprising a laser irradiation function according to the present invention, it is possible to determine the completion of ion milling processing based on the number of rings at which laser scattered light from the sample is detected.

### LIST OF REFERENCE NUMERALS

001 Sample tilting/rotating mechanism
002 Ion source
003 Ion beam
004 Sample chamber
005 Evacuating system
006 Sample stage
007 Ion current measurement device
008 High-voltage unit
009 Argon gas supply source
010 Flow rate control unit
011 Ion source/sample stage/gas control unit
012 SEM electron gun
013 Backscattered electron detector
014 Electron beam
015 Secondary electrons
016 Backscattered electrons
017 Secondary electron detector
018 SEM control system unit
019 Laser light source
020 Laser light
021 Ring-shaped detector
022 Scattered light before processing
023 Scattered light after processing
024 Control system unit
101 Sample
102 Sample table
103 Tilting shaft
104 Sample holder
105 Rotating shaft
106 Drive arm
107 Rotating plate
108 Sample tilt angle (θ1)
109 Sample tilt angle (θ2)
110 Spring
111 Inside gear
112, 113 Ion beam irradiation range
114 Pin attached to rotating plate
115 Profile
116 Threshold
117 Ring

1. A processing device that processes a sample by irradiating the sample with an ion beam, the processing device comprising a sample tilting/rotating mechanism that rotates/tilts the sample relative to the ion beam, wherein
the sample rotating mechanism comprises a rotating shaft that rotates the sample relative to the ion beam, and a tilting shaft that is orthogonal to the rotating shaft and that tilts the sample relative to the ion beam, the sample tilting/rotating mechanism being adapted to simultaneously perform the rotating and tilting of the sample.

2. The processing device according to claim 1, wherein
the sample tilting/rotating mechanism comprises a first rotating member connected to the rotating shaft, a second rotating member that rotates in conjunction with the first rotating member, and a sample table on which the sample is mounted, and
the sample table is connected to the second rotating member and tilts with the tilting shaft as the second rotating member rotates.

3. The processing device according to claim 2, further comprising a member that alters the position of a connecting part between the second rotating member and the sample table with respect to a distance from a center of the second rotating member.

4. The processing device according to claim 1, wherein the rotating shaft is rotated by a rotary drive of a sample stage of the processing device.

5. The processing device according to claim 1, further comprising:
an electron irradiation system that irradiates the sample with an electron beam;
a detector that detects an electron generated from the sample; and
a control device that terminates the irradiating of the sample with the ion beam based on a signal detected by the detector.

6. The processing device according to claim 5, wherein the control device irradiates a processing surface of the sample with the electron beam, and terminates the irradiating of the sample with the ion beam when the number of signals detected by the detector that exceed a predetermined signal amount becomes equal to or less than a predetermined number.

7. The processing device according to claim 1, comprising:
a laser irradiation system for irradiating the sample with laser light; and
a detector that detects laser light reflected or scattered by the sample,
the processing device further comprising a control device that terminates the irradiating of the sample with the ion beam based on a signal detected by the detector.

8. The processing device according to claim 7, wherein a detection surface of the detector comprises an opening through which the laser light passes, and wherein the processing device comprises a detection surface that is concentrically divided relative to the opening.

9. A sample drive mechanism used in a processing device that processes a sample by irradiating the sample with an ion beam, the sample drive mechanism comprising:
a rotating shaft that rotates the sample relative to the ion beam; and
a tilting shaft that is orthogonal to the rotating shaft and that tilts the sample relative to the ion beam, wherein
the sample drive mechanism is adapted to simultaneously perform the rotating and tilting of the sample.

10. The sample drive mechanism according to claim 9, further comprising:
a first rotating member connected to the rotating shaft;
a second rotating member that rotates in conjunction with the first rotating member; and
a sample table on which the sample is mounted, wherein
the sample table is connected to the second rotating member and tilts with the tilting shaft as the second rotating member rotates.
